(19) United States
(12) Patent Application Publication
(10) Pub. No.: US 2022/0101249 A1
(43) Pub. Date: Mar. 31, 2022

(54) APPARATUSES, METHODS, AND SYSTEMS FOR DELIVERY TRACKING, ROUTE PLANNING, AND RATING

(71) Applicant: GM GLOBAL TECHNOLOGY OPERATIONS LLC, Detroit, MI (US)

(72) Inventors: Alec M. Wuorinen, Detroit, MI (US); Amanda J. Kalhous, Ajax (CA); Marco J. Gatti, Grosse Ile, MI (US); Jarvis Chau, Markham (CA)

(73) Assignee: GM GLOBAL TECHNOLOGY OPERATIONS LLC, Detroit, MI (US)

(21) Appl. No.: 17/037,783

(22) Filed: Sep. 30, 2020

(51) Int. Cl. G06Q 10/08; G06Q 10/06; G06Q 30/06; G07C 5/00; G01C 21/34; G01S 19/01; G01P 15/00

(52) U.S. Cl. CPC G06Q 10/0832; G06Q 10/0833; G06Q 10/0635; G06Q 30/0633; G06K 19/06028; G06Q 10/06393; G01C 21/3415; G01S 19/01; G01P 15/00; G07C 5/008

(57) ABSTRACT

Apparatuses, methods, and systems are provided of a backend server communicating with vehicles equipped with an ePallet to identify delivery damage-causing events by a processor communicating with delivery vehicles with an ePallets in a transport of a package in delivery to customers; receiving location to identify locations that exhibit a likelihood to cause damage to the package; determining a location that exhibits the likelihood to cause package damage by analysis of acceleration data received from a first accelerometer located with the delivery vehicle and a second accelerometer located with the ePallet; compiling a set of events based on acceleration data from the first and second accelerometer indicative of an ePallet's movement desynced to a delivery vehicle's movement that can cause package damage; and notifying the delivery vehicle of an event likely causing package damage so the delivery vehicle can re-route navigation of the package delivery to prevent package damage.

### BACKGROUND

The present disclosure generally relates to delivery management, and more specifically to apparatuses, methods, and systems that use artificial intelligence to analyze sensed data for tracking the loading and delivery of packages to predict events that cause package damage in the delivery transport of the packages and to calculate a delivery score to compare aspects of delivery operations and to rate delivery service providers.

The operation of modern vehicles is becoming more automated, i.e., able to provide driving control and other functionalities with less driver intervention. Vehicle automation has been categorized into numerical levels ranging from zero, corresponding to no automation with full human control, to five, corresponding to full automation with no human control. Various advanced driver-assistance systems (ADAS), such as cruise control, adaptive cruise control, and parking assistance systems, correspond to lower automation levels, while true “driverless” vehicles correspond to higher automation levels.

It is desirable to implement systems of a network that can collect real-time data of vehicle operations equipped with ePallets to transport packages to customers. It is desirable to implement delivery algorithms to identify package-damaging incidents based on sensed data generated by a group or fleet of delivery vehicles; and to generate a total delivery performance score based on a plethora of inputs, to identify repeat-problem locations, to automatically re-order items likely to be damaged in a delivery transport operation. It is also desirable to trace a package through multiple activities in each package transport cycle that make up an entire delivery process. It is further desirable to implement machine learning and artificial intelligence applications to analyze collected data by delivery vehicles equipped with ePallets to predict a likelihood of damage to a package en-route to a customer in a delivery cycle.

The above information disclosed in this Background section is only for enhancement of understanding of the background of the invention, and therefore it may contain information that does not form the prior art that is already known in this country to a person of ordinary skill in the art.

### SUMMARY

Disclosed herein are scoring and predictive apparatuses, methods, and system for package delivery operations of vehicles equipped with ePallets to enable at least re-ordering of items in advance of delivery based on predictive package damage data of packages transported by a set of vehicles and en-route to a delivery destination. By way of example, and not limitation, there is presented a delivery vehicle equipped with an ePallet with onboard vehicle machine learning and control systems using collected data from a fleet of delivery vehicles for predicting events in delivery operations.

In an exemplary embodiment, an apparatus for identifying damage-causing events related to a package in a delivery activity is provided. The apparatus includes a processor at a backend server in communication with one or more delivery vehicles, each delivery vehicle equipped with an ePallet for effecting a delivery of at least one package to a customer, the processor operative to: communicate and maintain a communication link between one or more delivery vehicles equipped with ePallets in a transport of at least one package in one or more stages of the delivery activity to customers; receive a plurality of location data in one or more delivery stages to identify locations that exhibit a likelihood to cause damage to the package that is being delivered wherein the package being delivered is carried in the ePallet of an equipped delivery vehicle performing a delivery activity; determine a location that exhibits the likelihood to cause package damage by analysis of acceleration data by algorithms of the processer wherein the acceleration data is received from a first accelerometer located with the delivery vehicle and a second accelerometer located with the ePallet that carries the package for delivery; compile a set of events based on acceleration data from the first and second accelerometer together with location indicative by the analysis of the accelerometer data by the algorithms of the processor of an ePallet's movement desynced to a delivery vehicle's movement that can cause package damage; and notify the delivery vehicle in a package delivery activity of an event likely causing package damage for the delivery vehicle to re-route a transport of the package delivery for avoidance of an identified damage causing location.

In various exemplary embodiments, the apparatus further includes the processor at the backend server in communication with the one or more delivery vehicles equipped with the ePallet operative to: re-order an item predicted to incur damage based on a compiled event indicative of causing package damage in advance of delivery of the package to the customer. The apparatus further includes the processor at the backend server in communication with the one or more delivery vehicles equipped with the ePallet operative to: compile the set of events based on acceleration data received from a historical database of prior determining locations that have exhibited the likelihood to cause package damage.

The apparatus further includes the processor at the backend server in communication with the one or more delivery vehicles equipped with the ePallet operative to calculate a total delivery score for a delivery service based on analysis of a set of input of delivery activities including a loading score, a number of customer feedback damage report, a number of re-orders of replacement items, and a driving score in transporting the package for delivery. The apparatus further includes the processor at the backend server in communication with the one or more delivery vehicles equipped with the ePallet operative to: validate the re-order the item predicted to incur damage based on the customer feedback damage report. The apparatus further includes the processor at the backend server in communication with the one or more delivery vehicles equipped with the ePallet operative to calculate the driving score based on data of analysis of differences of the accelerometer data by the algorithms of the processor of an ePallet's movement desynced to a delivery vehicle's movement that can cause package damage. The apparatus further includes the processor at the backend server in communication with the one or more delivery vehicles equipped with the ePallet operative to: calculate the loading score based on a measure of a number of touches recorded of the package in transporting the package for delivery wherein each touch is identified by a barcode affixed to the package that is scanned in package delivery activities.

The apparatus further includes the processor at the backend server in communication with the one or more delivery vehicles equipped with the ePallet operative to: trace the package using the barcode that has been affixed to the package. The apparatus further includes the processor at the backend server in communication with the one or more delivery vehicles equipped with the ePallet operative to calculate the total delivery score for a delivery service based on a different weight attribute to each input of the set of input of delivery activities.

In another exemplary embodiment, a method performed by a processor including communicating between the processor and one or more delivery vehicles equipped with ePallets in a transport of at least one package in one or more delivery activities to transport packages to customers; receiving, by the processor, a plurality of location data in one or more delivery activities for identifying locations exhibiting a likelihood for causing damage to the package in a course of a delivery wherein the package delivered is carried in the ePallet of an equipped delivery vehicle performing a particular delivery activity; determining, by the processor, a location exhibiting a likelihood causing package damage by analyzing acceleration data by algorithms of the processer wherein the acceleration data is received from a first accelerometer located with a delivery vehicle and a second accelerometer located with the ePallet carrying a delivery package; determining, by the processor, a set of events by analyzing acceleration data from the first and second accelerometer together with location using algorithmic solution of an ePallet's movement desynced to a delivery vehicle's movement that can cause package damage; and notifying the delivery vehicle in performance of a package delivery activity of an event likely causing package damage for the delivery vehicle enabling re-routing of a transporting of the package delivery to avoid a damage causing location.

In various exemplary embodiments, the method further includes re-ordering, by the processor, an item predicted to incur damage based on a compiled event indicative of causing package damage in advance of delivery of the package to a customer. The method further includes compiling, by the processor, by the set of events based on acceleration data received from a historical database of prior determining locations that have exhibited the likelihood to cause package damage. The method further includes calculating, by the processor, a total delivery score for a delivery service based on analysis of a set of inputs of delivery activities including a loading score, a number of customer feedback damage report, a number of re-orders of replacement items, and a driving score in transporting the package for delivery. The method further includes validating, by the processor, the re-order the item predicted to incur damage based on the customer feedback damage report. The method further includes calculating, by the processor, the driving score based on data of analyzing differences of the accelerometer data using algorithms of the processor of an amount of ePallet's movement desyncing to a delivery vehicle's movement related to causing package damage. The method further includes calculating, by the processor, the loading score based on measuring of a number of touches occurring to a package in transporting the package for delivery wherein each touch is identified by a barcode affixed to the package that is scanned in package delivery activities. The method further includes tracking, by the processor, the package using the barcode that has been affixed to the package. The method further includes calculating, by the processor, the total delivery score for a delivery service based on a different weighting attributed to each input of the set of input of delivery activities.

In yet another exemplary embodiment, a smart delivery system for transporting packages to customers is provided. The smart delivery system includes a processor at an backend server in communication with one or more delivery vehicles, each delivery vehicle equipped with an ePallet for effecting a delivery of at least one package to a customer, the processor operative to: communicate and maintain a communication link between one or more delivery vehicles equipped with ePallets in a transport of at least one package in one or more stages of the delivery activity to customers; receive a plurality of location data in one or more delivery stages to identify locations that exhibit a likelihood to cause damage to the package that is being delivered wherein the package being delivered is carried in the ePallet of an equipped delivery vehicle performing a delivery activity; determine a location that exhibits the likelihood to cause package damage by analysis of acceleration data by algorithms of the processer wherein the acceleration data is received from a first accelerometer located with the delivery vehicle and a second accelerometer located with the ePallet that carries the package for delivery; compile a set of events based on acceleration data from the first and second accelerometer together with location indicative by the analysis of the accelerometer data by the algorithms of the processor of an ePallet's movement desynced to a delivery vehicle's movement that can cause package damage; and notify the delivery vehicle in a package delivery activity of an event likely causing package damage for the delivery vehicle to re-route a transport of the package delivery for avoidance of an identified damage causing location.

In various exemplary embodiments, the system further includes the processor at the backend server in communication with the one or more delivery vehicles equipped with the ePallet operative to: re-order an item predicted to incur damage based on a compiled event indicative of causing package damage in advance of delivery of the package to the customer wherein the compiled event is based in part on acceleration data received from a historical database of previously determined locations that have exhibited the likelihood to cause package damage.

The exemplifications set out herein illustrate preferred embodiments of the invention, and such exemplifications are not to be construed as limiting the scope of the invention in any manner.

### BRIEF DESCRIPTION OF THE DRAWINGS

The above-mentioned and other features and advantages of this invention, and the manner of attaining them, will become more apparent, and the invention will be better understood by reference to the following description of embodiments of the invention taken in conjunction with the accompanying drawings.

FIG. 1 illustrates a block diagram depicting an example vehicle equipped with an ePallet, each with an associated accelerometer, and a processor in communication with a server that makes up the smart cargo system in accordance with an embodiment;

FIG. 2 illustrates an exemplary flow diagram of a calculating process by the processor of the overall delivery score of the smart cargo system in accordance with an embodiment;

FIG. 3 illustrates an exemplary flow diagram of calculating an input of the loading score of the overall delivery score of the smart cargo system in accordance with an exemplary embodiment;

FIG. 4 illustrates an exemplary flow diagram for comparing the vehicle equipped with an ePallet and multiple accelerometers to determine package integrity by the smart cargo system in accordance with an embodiment;

FIG. 5 is an exemplary flow diagram of operations of the smart delivery process for determining by the smart cargo system whether re-order a replacement item in accordance with an exemplary embodiment;

FIG. 6 is an exemplary flow diagram for collecting GPS data and timing data from multiple delivery vehicles to predict and to minimize package damage in the smart delivery process of the smart cargo system in accordance with an exemplary embodiment;

FIG. 7 is an exemplary flow diagram of operations using customer input for determining enhanced package damage predictions in the smart delivery process of the smart cargo system in accordance with an exemplary embodiment;

FIG. 8 is an exemplary flow diagram for calculating the overall delivery score in the smart delivery process of the smart cargo system in accordance with an exemplary embodiment; and

FIGS. 9A, 9B, 9C, 9D, and 9E illustrate exemplary flow diagrams of various use cases of stages of the smart delivery system in accordance with an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Various nomenclature is used throughout the present disclosure, for example, including an ePallet is a structural foundation of a unit load or container which allows handling and storage efficiencies. In an exemplary embodiment, an ePallet is a container that can be tracked with a barcode or other electronic tagging device and can be used by a vehicle to load a package onto or to load multiple packages at once. The ePallet may include an individual package that contains one or more items. A package can include covering or wrapping an item that is often protective in nature with identification (i.e., a barcode affixed) for tracking, and the package can be easily loaded and conveyed in operations to a destination for receipt by a customer.

In various exemplary embodiments, the present disclosure describes an apparatus, method, and system to monitor goods to improve delivery routes by comparing accelerometer data between a vehicle and a container (ePallet) stored within to identify potentially significant instances or events in a delivery that can cause damage to the items carried by the ePallet, or delay the transport of the item to the destination and/or customer.

In various exemplary embodiments, the present disclosure describes an apparatus, method, and system to compiling, aggregate, and/or crowdsource GPS data from a series of deliveries to identify locations where items are likely damaged and in which this location data can be used to make routing decisions in the transportation of the items for delivery to customers.

In various exemplary embodiments, the present disclosure describes an apparatus, method, and system to provide an accurate assessment regarding the efficiency of package-handling workers, which is used to inform an overall delivery score that includes a loading score and driving score.

In various exemplary embodiments, the present disclosure describes an apparatus, method and system to use GPS within a package-storing container (ePallet) that is transferred from a delivery vehicle to any other delivery vehicle (ex. Bike, automobile, person, etc.) to enable monitoring locations through an entire delivery process, including after the package leaves a vehicle.

In various exemplary embodiments, the present disclosure describes an apparatus, method and system to aggregate, collect and crowdsource together vehicle and package data for analysis by using machine learning and artificial intelligence techniques to develop models to determine the likelihood of package damaging events in order to minimize damage to items delivered to customers.

In various exemplary embodiments, the present disclosure describes an apparatus, method, and system for identifying repeat-problem locations and times and to enable by the smart cargo system an automatic re-ordering of an item if damage to the item is suspected of having occurred in the loading and transport stages to the customer.

In various exemplary embodiments, the present disclosure describes an apparatus, method, and system to apply Machine Learning (ML) techniques to enable continuous refinement of the predict processes of the likelihood of damaged goods in delivery operations of multiple or a fleet of connected vehicles equipped with ePallets used for delivery, to analyze the data for anomalies in delivery transport operations related to events and location that cause vehicular driving systems to package damaging event such as incurring in route navigations hard braking, wheel slippage or stoppage that cause damage to items of packages and to send warnings and instructions in advance to vehicles making deliveries to avoid or circumvent a damaging package event.

In various exemplary embodiments, the present disclosure describes an apparatus, method, and system to enable precise measurements of the efficiency of delivery services to incentivize productivity and to provide more data to the customers about delivery services, including GPS location regardless of a type of delivery vehicle equipped with an ePallet (e.g., by using a combination of GPS module on ePallet, data on the vehicle, and predictive data on the backend server).

In various exemplary embodiments, the present disclosure describes an apparatus, method, and system to enable instant and automatic re-ordering of an item suspected of incurring damage, to identify locations that cause damage to items, to enable better route planning that avoids these locations, to enable integration with other/existing driving scores (e.g., ONSTAR®), to enable the enhanced integrity of the package delivered, and to make detectable determinations if routes have been recalculated based on predictive damage algorithms (e.g., route planning to avoid damaged road when otherwise inefficient to do take that route).

In various exemplary embodiments, the present disclosure provides loading, driving, and delivery scores using algorithms of a processor. The scores can be used to improve the loading of packages, to make enhancements to delivery routes, and to improve overall driver performance.

In an exemplary embodiment, the loading score may be defined as the efficiency rating of preparing an item for delivery, calculated by the smart cargo system by measuring the number of touches (e.g., using Camera or self-reported by an associate) on a package by delivery associates and the time taken to load the package into the delivery vehicle or ePallet (e.g., the time between scanned packages).

In an exemplary embodiment, the driving score may be defined as the efficiency rating of transporting an item to the customer in-vehicle, calculated by the smart cargo system by measuring the difference, if any, between vehicle and ePallet accelerometers.

In an exemplary embodiment, the delivery score may be defined as a comprehensive efficiency rating of the beginning-to-end delivery of one or more items and is calculated by the smart cargo system.

In various exemplary embodiments, the present disclosure describes an apparatus, method, and system with calculation's inputs for the smart cargo system that include: a loading score, a customer's report if an item is damaged, drive time to reach the customer, an order of a new item if applicable, and a driving Score.

In various exemplary embodiments, the present disclosure provides a cargo delivery for improved package integrity and propulsion system efficiencies with delivery algorithms to minimize package damage through identified damaging ‘events.’ The ‘event’ may be defined as a potentially significant instance in the transportation of an item. The event is created when the vehicle accelerometer doesn't match or is not in sync with the ePallet accelerometer. The compilation of events in the execution of multiple deliveries can allow for the creation of a database (i.e., a smart cargo database) that can be accessed to identify when and where the damage event occurred to an item in the transport of an item or the course of an item being delivered.

In various exemplary embodiments, the present disclosure describes an apparatus, method, and system to enable clear or better tracing of a package in the loading and delivery transport through the entire delivery process that consists of multiple stages of the deliverance of an item. This includes the instance after the item leaves a delivery vehicle (e.g., the ePallet is removed from the vehicle and conveyed manually by a transporting person to a residence or multiple residences for multiple packages on an ePallet for delivery) to the instance the item is received and reviewed by the customer for damage at the delivery destination.

In various exemplary embodiments, the present disclosure describes an apparatus, method, and system that takes into account a package's attributes such as weight and size, to configure a better delivery route or for more efficient battery use in the case of electric or hybrid propulsion systems in vehicle delivery transport and package delivery. This may entail re-routing by the cargo system of delivery routes based on sensor data from the ePallet via communications to the delivery service or driver. Also, the ePallet accelerometer may also automatically assist in generating a better or enhanced navigation route for route instruction to a propulsion system of the vehicle. That is, the ePallet may be configured with other sensors to generate data as well as the accelerometer data of the ePallet may improve the propulsion system efficiency and delivery route selection by allowing a larger package (or a heavier) to be delivered faster (and more safely) in a different or more convenient route selection (taking into account obstacles in the delivery route) that can not only improve (if the vehicle relies on a battery pack) the battery range on the vehicle, but also the ease of delivery by the delivery transport service or person (especially for fragility, and other package characteristics gleaned by the smart cargo system) that may or may not be readily apparent at the onset, and during the delivery process.

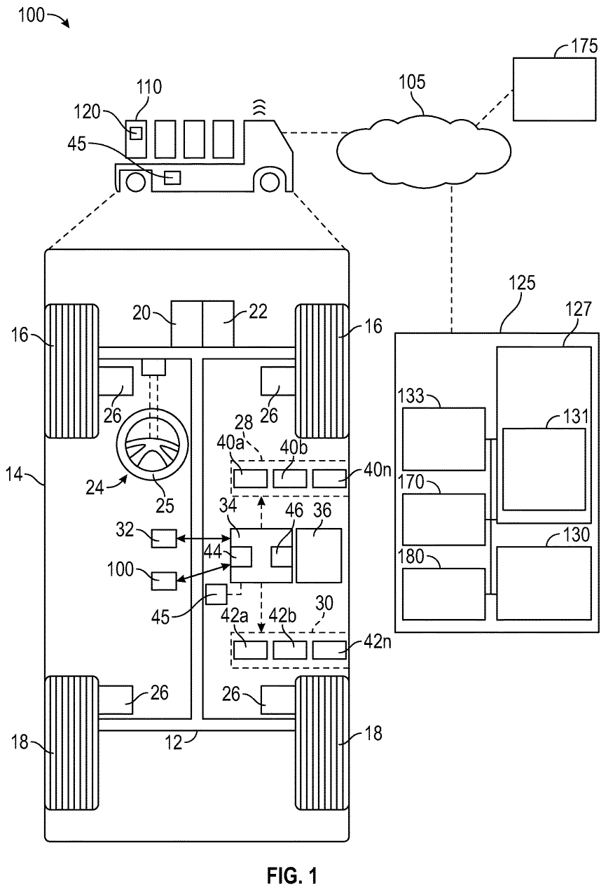

FIG. 1 illustrates a block diagram depicting an example, vehicle 10 that may include an ePallet 110 with an accelerometer 120, which is independent of the vehicle 10, a processor 44, an accelerometer 45 with the vehicle 10, a backend server 125, a processor 127 of the backend server 125, and a service provider 175 that make up the smart cargo system 100 in accordance with an embodiment. In general, input data is received by the smart cargo system (or simply “system”) 100. The system 100 determines an overall delivery score based on the data received.

The system 100 provides multiple benefits that include monitoring items and improving delivery routes by comparing accelerometer data between a vehicle and a container (ePallet) stored within to identify potential package damage-causing instances in a delivery cycle. Further, the system 100 compiles the GPS data collected from a fleet of delivery vehicles equipped with ePallets performing multiple stages or operations of aspects of delivery cycles to enable a set of delivery related process functions. These delivery process functions include to identify locations that are hazardous to transport packages, to make delivery route navigation decisions, to assess delivery performance, to generate an overall delivery score, to track via GPS the delivery package, to collect ePallet accelerometer data, to collect vehicle accelerometer data, to collect and store package data, to identify and predict damaging events and locations in advance, and to analyze aggregated historical delivery recorded data by machine learning models or artificial intelligence techniques to make suggestions to improve each aspect of the delivery process.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The vehicle wheels 16-18 are each rotationally coupled to the chassis 12 near a respective corner of the body 14. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used. While the present disclosure is depicted in the vehicle 10, it is contemplated that the methodology presented is not limited to transportation systems or the transportation industry, but is and has applicability to any services and devices where the smart cargo system is implemented. In other words, it is believed that the presented described methods, systems, and apparatus directed to the smart cargo systems have broad applicability in a variety of diverse fields and applications.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in this example, include an electric machine such as a permanent magnet (PM) motor or the like, as well as other electric and non-electric are also equally applicable. The transmission system 22 is configured to transmit power from the propulsion system 20 to the vehicle wheels 16 and 18 according to selectable speed ratios.

The brake system 26 is configured to provide braking torque to the vehicle wheels 16 and 18. Brake system 26 may, in various exemplary embodiments, include friction brakes, brake by wire, a regenerative braking system such as an electric machine, and/or other appropriate braking systems.

The steering system 24 influences the position of the vehicle wheels 16 and/or 18. While depicted as including a steering wheel 25 for illustrative purposes, in some exemplary embodiments contemplated within the scope of the present disclosure, the steering system 24 may not include a steering wheel.

The sensor system 28 includes one or more sensing devices 40a-40n that sense observable conditions of the exterior environment and/or the interior environment of the vehicle 10 and generate sensor data relating thereto.

The actuator system 30 includes one or more actuator devices 42a-42n that control one or more vehicle features such as, but not limited to, the propulsion system 20, the transmission system 22, the steering system 24, and the brake system 26. In various exemplary embodiments, vehicle 10 may also include interior and/or exterior vehicle features not illustrated in FIG. 1, such as various doors, a trunk, and cabin features such as air, music, lighting, touch-screen display components, and the like.

The data storage device 32 stores data that can be used in controlling the vehicle 10. In various exemplary embodiments, the data storage device 32 or similar systems can be located onboard (in the vehicle 10) or can be located remotely on the cloud, or server, or a personal device (i.e., smartphone, tablet, etc.) The data storage device 32 may be part of the controller 34, separate from the controller 34, or part of the controller 34 and part of a separate system. The data storage device 32 may be in communication with the smart database 133 that stores historical event data for use by the smart cargo system 100.

The controller 34 includes at least one processor 44 (integrate with system 100 or connected to the system 100) and a computer-readable storage device or media 46. The processor 44 is in communication with the processor 127 of the smart cargo system 100 to receive instructions and send information such as GPS data, time data, etc. for use by the smart cargo system 100. For example, the prediction engine 131 configured with the processor 127 can be programmed or instructed to determine events based on data received from the processor 44. The processor 44 may be any custom-made or commercially available processor, a central processing unit (CPU), a graphics processing unit (GPU), an application-specific integrated circuit (ASIC) (e.g., a custom ASIC implementing a neural network), a field-programmable gate array (FPGA), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals (e.g., sensor data) from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

As an example, system 100 may include any number of additional sub-modules embedded within the controller 34, which may be combined and/or further partitioned to similarly implement systems and methods described herein. Additionally, inputs to the system 100 may be received from the sensor system 28, received from other control modules (not shown) associated with the vehicle 10, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

In FIG. 1, the communication network 105 is configured to connect the vehicle 10 and/or a group or fleet of delivery vehicles to the smart cargo system 100, as an example, in the cellular domain by a backend server of a carrier network that enables the collecting and aggregating of real-time streaming data from a fleet of delivery vehicles (i.e., vehicle 10) within a designated control zone. The backend server 125 can analyze the collected data for various anomalies or package damaging events such as hard braking, wheel slippage, stoppage, and so on in the transport of items for delivery. If an anomaly is detected, the communication network 105 is configured to send an instruction (i.e., message) or send multiple instructions to relevant vehicles for alerting each relevant vehicle about a particular driving warning such as the location of an event that likely will cause damage to a delivery item in transport. The receipt of the warning can enable automated vehicle features to avoid or compensate for the hazardous event or the driver to make changes in the transport route to avoid the event location. In exemplary embodiments various automated vehicle features can include the need for automatic emergency braking, and the like or to instruct the advanced driver assistance systems (ADASs) to change a feature state of an ECU system in the vehicle at an appropriate time and location determined by the detected anomaly or event on a transport road segment and current vehicle speed, location, and path, etc.

In FIG. 1, the data is continuously streamed off (i.e., transmitted) vehicles 10 to a cellular network and back to the vehicle 10 over a continuously connected messaging protocol such as MQTT or DDS. The data from the vehicle 10 is directed by the cellular network to the backend server (i.e. backend server 125) that controls the geographic area in which the vehicle 10 is located. Each packet of data received via the message gateway 130 is decoded and/or encoded at a data decoder/encoder. When the data packet is decoded at the message decoder/encoder, the values extracted from the message are written into in-memory digitally of at least a set of delivery vehicles of a fleet of delivery vehicles. That is, the fleet and/or delivery vehicle distributes the decoded packet data message to the relevant vehicles where the relevancy of a vehicle is determined based on an identified parameters including vehicle location, vehicle direction, time of the message extracted, type of information gleaned from the decoded message, etc. For example, a set of events for vehicles in the fleet can be predicted by the prediction engine 131 based on the data extracted and processed by the fleet and the delivery vehicle or can be continuously predicted in the absence of and/or in between updates from the vehicle (e.g., Kalman filtering) that results in making predictions of vehicles' current location, roadway locations, and vehicle heading directions. The event detector 170 processes vehicle states which have been analyzed to respond to damage-causing events or to changes determined from accelerometer data in the sync of the accelerometer 120 and accelerometer 45. For example, the desync between the accelerometers can be because of a hard braking or a stoppage and the corresponding hard braking state or stoppage state of the vehicle 10 which can cause damage to package and items in delivery. Upon recognition of a particular change between the accelerometers and/or a vehicle state (i.e., a detection of a changed vehicle feature state), a notification can be generated and sent to a command manager 180, which in turn sends notifications to alert via broadcasting messages to nearby vehicles in the vicinity to have advanced knowledge end of a responsive action taken to the package damaging event or anomaly and to anticipate or alert the driver of potentially required action to be taken if applicable to the vehicle. The command manager 180 reviews data of nearby vehicles from the smart cargo database 133 by a spatial query and selects vehicles traveling behind the package damage-causing event on the same roadway. The commands sent by the command manager 180 follow a path or processing pipeline via the message decoder/encoder to the message gateway 130, exiting the backend server 125 via the cellular network and communicating the command to the vehicle ADAS or the driver of the vehicle 10. Also, vehicle 10 can notify the driver or ADAS upon receipt of the message.

Hence, smart cargo system 100 is operative to perform a methodology to predict a future event or a feature state of an automatic driving system (i.e., ECU) to provide drivers with early feedback and prevent package damage in delivery. The methodology is also operative to predict events based on the crowdsourced fleet data that results in improvements routes for package delivery, performance and rating of delivery service providers 175 in usage of ePallet equipped motor vehicles. The methodology may use a model trained (i.e. the prediction engine 131) using the collected, historical, and crowdsourced data from an automated, semi-automated, and non-automated driving delivery vehicle and fleet by finding micro patterns at a delivery road segment level, and macro patterns independent of location. The method may then model package damage-causing events found by fleet collected data, historical data, and the crowdsourcing in the vehicle delivery operations in future segments of the predicted vehicle path, and send advance warnings as the vehicle continues operation to the next road segments.

In an exemplary embodiment, the processor at the backend server is operative to receive the data streamed in real-time from a transceiver located at the vehicle and to receive instructions for various navigation and ADAS operating state transition predictions based on analytic algorithms implemented by the processor 127 performing predictive analysis based on current and historical data from a smart cargo database 133 and/or from aggregated or crowdsourced data where the predicted damage-causing events and are derived using machine learning models or trained model or other artificial intelligence techniques (i.e. the prediction engine 131) at the backend server 125. This is because the remote backend server is configured to communicate continuously and collect streamed data from multiple vehicles (i.e., a real-time streamed crowdsourced of fleet delivery vehicle data communication and collection).

Further, in an alternate exemplary embodiment, the processor 127 at the backend server can communicate with the processor 44 which is contained in the vehicle, to receive data from a smart cargo database 133 that communicates with the processor 127 at the backend server 125. In response to the modeling, the processor 127 is operative to generate a prediction indicative of a probability of encountering in advance of the damage-causing event by the vehicle based on factors that include timing, distance, speed, weather conditions of the environment of the vehicle or grouping and analysis of collected data of the multiple vehicles traveling behind or in the vicinity.

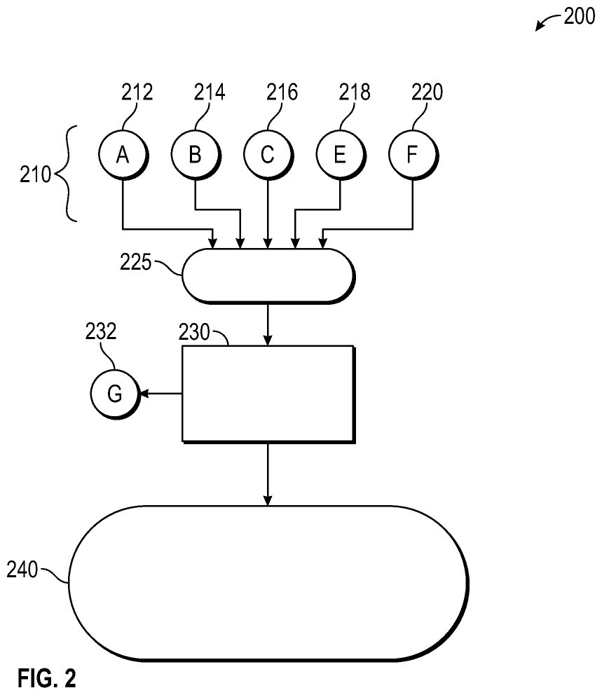

FIG. 2 is an exemplary diagram of the calculation of the overall delivery score by the smart cargo system in accordance with an embodiment. In FIG. 2, the smart cargo system 200 includes a set of inputs 210 of input “A” which is an input 212 of loading score, input “B” which is an input 214 indicative of a customer's report if the item was damaged, input “C” 216 which is an input 216 indicative of drive time to reach a customer, input “E” which is an input 218 indicative of ordering of a new item if applicable, and an input “F” which is an input 220 of a driving score for the vehicle. The set of inputs 210 are implemented by processors of the smart cargo system to calculate the overall delivery score using various algorithms and based on several factors. This algorithm provides a score quantifying the efficiency of the entire delivery of one or more items. Additional outputs of the algorithm include data for novel route-planning to minimize package-damage.

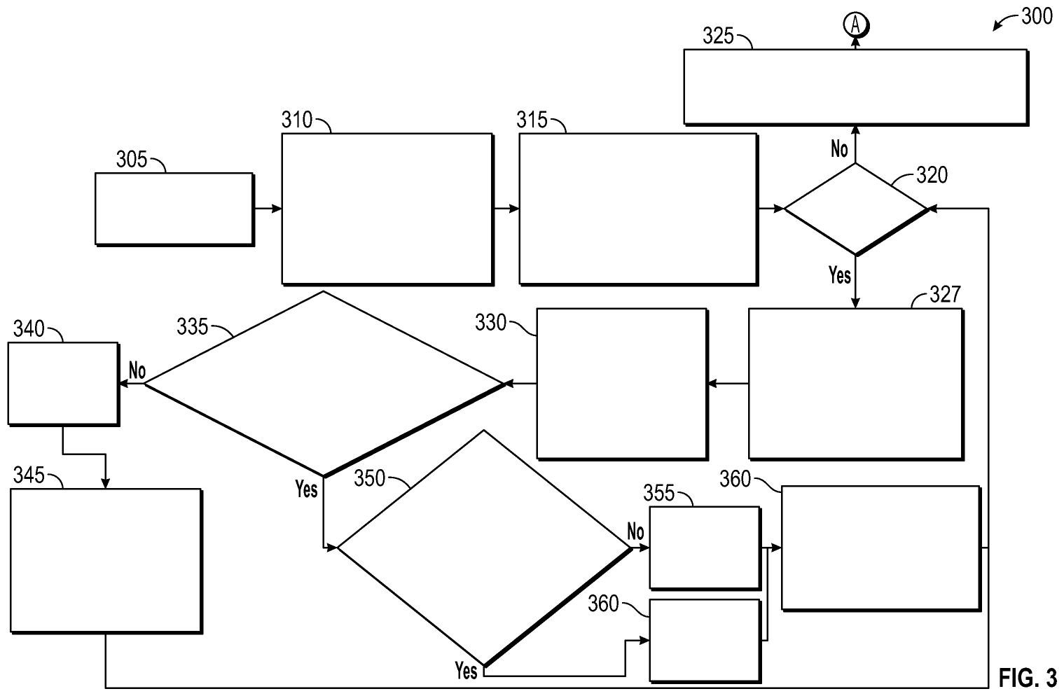

FIG. 3 illustrates an exemplary flow diagram of calculating an input of the loading score of the overall delivery score of the smart cargo system in accordance with an exemplary embodiment. Initially, at step 305, of the loading score calculation system 300, the smart cargo system identifies the package which is loaded. At step 310, the smart cargo system collects package parameters such as weight and size that have been previously collected, or is sensed, or manually/automatically recorded (e.g., via stored barcode data) for further processing. At step 315, the smart cargo system creates a timestamp that is both indicative and used when initiating the start of a package loading process. That is, the timestamp is scanned for the first time, or an ePallet's accelerometer reading is detected with a nonzero reading. Then at step 320, a determination is made whether there are more packages to load. If not, then at step 325, the smart cargo system reports the final loading score taking into account the number of packages loaded, the parameter data of each of the packages loaded (i.e., the size and weight of each package) while determining a measure of the number of touches and the amount of time to load each package. Alternately, if there are more packages to load, then the flow proceeds to step 327, where the smart cargo system records the number of touches that are associated with each package (e.g., measuring using a computer vision methodology with a camera in a warehouse or handheld devices, or by manual employee counts of the number of touches). At step 330, the smart cargo system records the time to load each package (e.g., measuring using the timestamp associated with the barcode which has been scanned). At step 335, the smart cargo system determines whether the smart cargo database has any historical data with similarity to a current package that is loaded. For example, data of similar packages in size and weight in order to make by the smart cargo system pre-loaded barcode data comparisons that identify the similar size and weight packages. If this is not the case, then flow proceeds to step 340, and the loading score remains unchanged. At step 345, the smart cargo system uses loading time and number of touches recorded to create a new baseline for packages of approximately the retrieved similar size and weight.

If there exists prior historic data for retrieval (as determined by the smart cargo system at step 335), then at step 350, the smart cargo system records the number of touches and or loading time for the current package to make a comparison with historical data. If a higher number of touches has been recorded, then the flow proceeds to step 360, indicates that the loading score at 360 has worsened. If a lower number of touches is recorded, then the flow proceeds to step 355, indicative that the loading score has improved.

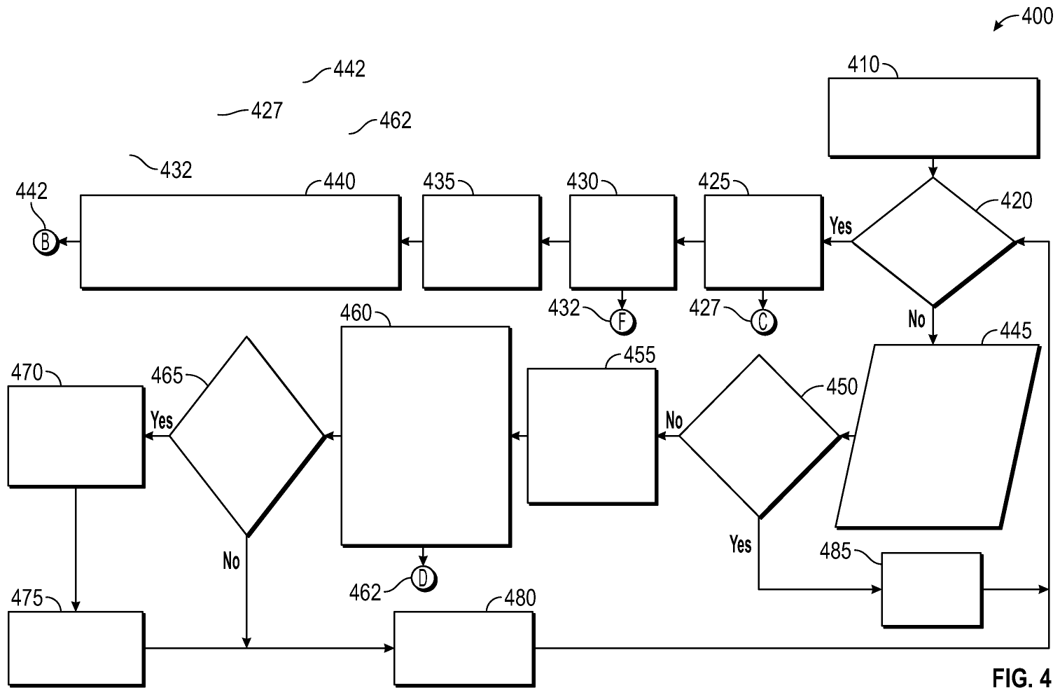

FIG. 4 illustrates an exemplary flow diagram to compare the vehicle and the ePallet accelerometers to determine package integrity by the smart cargo system in accordance with an embodiment. In FIG. 4, the smart cargo system generates a set of outputs based on comparisons of the differences in movement or acceleration of the vehicle and the ePallet that carries the packages. That is, the vehicle and the ePallet (which contains the package) move in unison or independently depending on the step or chain in the smart cargo system's delivery process. The set of outputs includes output “B” which is an output 442 that creates or sends a customer's report if the package or item is damaged or is likely to be damaged based on sensed or historical data comparisons; output “C” which is an output 427 that is the amount of drive time experienced by the vehicle to reach a customer; output “D” which is an output 462 of event data that includes information such as time, location and accelerometer data of the vehicle and ePallet, and output “F” which an output 432 that creates or generates a driving score based on multiple factors.

Initial, the comparison process 400 of the vehicle and the ePallet accelerometers by the smart cargo system is initiated at step 410 by generating or configuring a package delivery with a pre-determined route that is calculated based on various applications and solutions of the smart cargo system.

In an exemplary embodiment, a re-routing of a navigation route based on epallet sensor data (i.e., weight, location of package in the delivery truck, and/or both) may be performed by the smart cargo system and the re-routed data may be sent to the driver via a telematic system or other communication network system or the like.

At step 420, the smart cargo system determines whether the package has arrived at the destination. If the package has arrived at the destination, then the flow proceeds to step 425, and the smart cargo system determines the drive time to reach the customer. At step 430, the smart cargo system can generate a final driver score based on an algorithm and report the final driver score an output 432 (i.e., output “F”). Next, the smart cargo system at step 435 proceeds to deliver the package to the customer. At step 440, the smart cargo system, upon delivery, can receive a customer report that the item of the package delivered is damaged. The customer report may be received by a customer feedback mechanism (i.e., survey request or email that is sent to the customer, etc.) If the customer fails to give any report, then the smart cargo system acts with the assumption that the item was delivered undamaged. If the item is damaged, then an output 442 (i.e., output “B”) is sent indicative of a damaged item.

Alternatively, at step 420, if the smart cargo system determines that the package by the GPS data of the ePallet or vehicle has not reached the customer destination, then at step 445, the smart cargo system measures and stores vehicle acceleration and ePallet acceleration data to ensure package integrity (e.g., using each data generated by the accelerator associated with the vehicle and the accelerator associated with the ePallet). Next, at step 450, the smart cargo system determines if data received from the ePallet accelerometer matches or is approximately similar to the vehicle's accelerometer data. If this is the case, then at step 485, the smart cargo system determines that the driver's score has improved. If it isn't the case, then at step 455, the smart cargo system notifies (via a message) the driver to drive more carefully. The message can be sent via a driver's smartphone or heads up display of the vehicle or any other display device that is driver accessible to view message data. At step 460, the smart cargo system creates an “Event” notification that can be added to a delivery log. The data added or stored in the delivery log (using a logging application) may also include accelerometer, GPS, and time data associated with the vehicle and ePallet. The accelerometer, GPS, and time data can be measured in various instances, time periods, etc. by the smart cargo system automatically.

In various exemplary embodiments, the data from the ePallet accelerometer may also assist in generating a better or enhanced navigation route for route instruction to a propulsion system of the vehicle. That is, the ePallet may be configured with other sensors to generate data as well as the accelerometer data of the ePallet may improve the propulsion system efficiency by allowing a larger package (or a heavier) to be delivered faster in a different route selection that can improve (if the vehicle relies on a battery pack) the battery range on the vehicle, but also takes into account the package weight and other related characteristics.

The data is sent via output 462 (i.e., output “D”). At step 465, a determination is made by the smart cargo system, whether the records associated with a third party such as a delivery company include any of the items that are currently being transported. If this is not the case, then at step 408, the smart cargo system determines that the driver score has worsened. If it is the case that the third party (i.e., the delivery company) has a specific record of the item for delivery, then at 470, the smart cargo system makes a determination based on the comparisons of the accelerometer data of the vehicle and ePallet whether any of the items are damaged. If it is determined that an item is damaged, then at step 475, the smart cargo system can send a message to a third-party vendor for a re-order. The flow then proceeds again to step 480, which is indicative by the smart cargo system that the driver score has worsened.

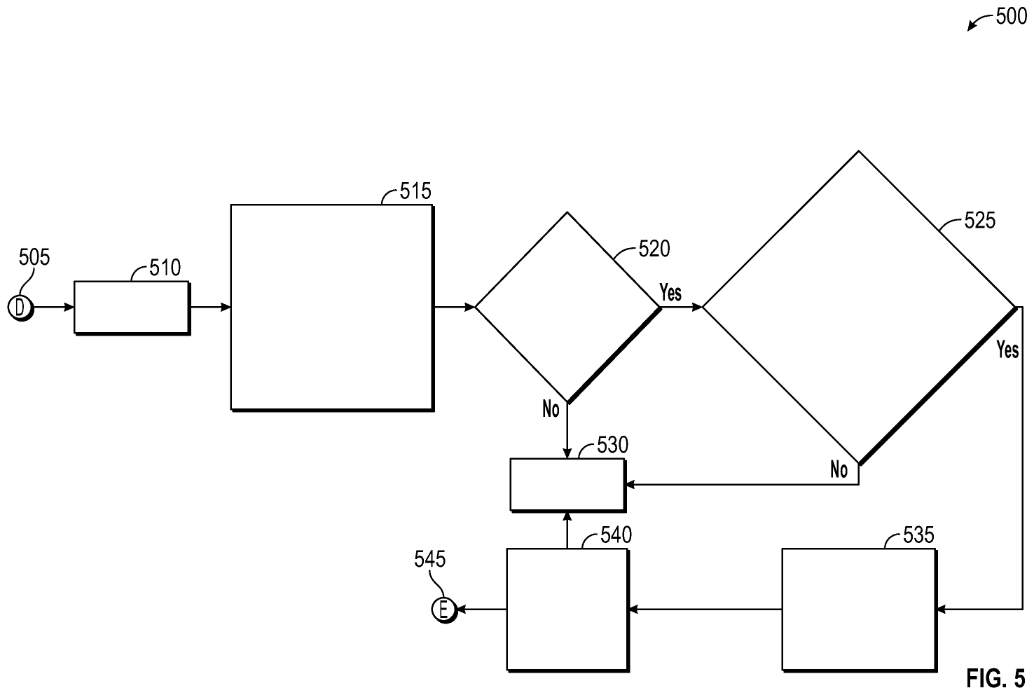

FIG. 5 is an exemplary flow diagram of a stage of the smart delivery process where a determination is made by the smart cargo system whether or not to order a new package in accordance with an exemplary embodiment. In FIG. 5, the order determination process 500 by the smart cargo system receives via input 505 (output 462, from FIG. 4) the event information of the time, location, and accelerometer data. In FIG. 5, at step 510, the smart cargo system determines that an event has been recorded. At step 515, the smart cargo system compares acceleration and data from the input 505 to any, almost all, or all of the previously recorded events that have been stored in the smart cargo database. For example, the smart cargo system may parse through records of events stored in the database one by one to identify similar acceleration data or values. At step 520, the smart cargo system determines whether an event with similar acceleration data to the data received in the input 505 has been recorded and is contained in the smart cargo database. If this is the case, then at step 525, the smart cargo system using various algorithmic solutions determines by the data received that there is a high likelihood a similar package and item is damaged, and further, based on this determination, decides whether to continue the delivery of the item. If it is determined that the data is not suggestive that the item is damaged, then the flow continues to step 530, which is indicative that the delivery is to continue. If not, then the flow continues to step 535, where the smart cargo system notifies the customer that there is (in advance of the delivery) a likelihood that the item in the package is damaged. The smart cargo system will, upon the notification, then at 540 automatically re-order a replacement item. In other words, the smart cargo system acts on the assumption that the package is damaged, the item is damaged, and this warrants re-ordering of the item. The smart cargo system generates an output “E” at output 545, which is a replacement order (i.e., new order) for the item in advance and will cancel the delivery of the likely damaged item that is occurring in the near future.

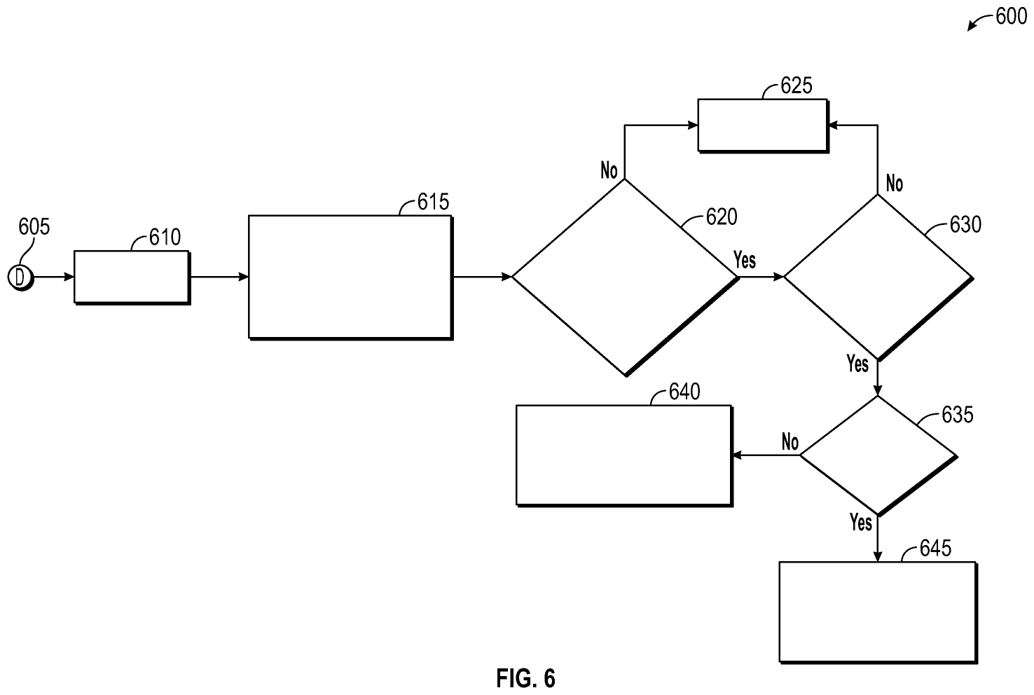

FIG. 6 is an exemplary flow diagram of a stage for the collection of GPS data and timing data to minimize package damage in the smart delivery process of the smart cargo system in accordance with an exemplary embodiment. In FIG. 6, the smart cargo system receives an input “D” which is an input 605 of event information including time, location, and accelerometer data. At step 610, in the smart delivery process flow, an “Event” is determined and is recorded with associated input 605 data, including event time, event location, and an event accelerometer measurement. At step 615, the smart cargo system compares time and GPS data received from the input 605 to historic (previously recorded) event data that has been stored in a smart cargo database that is in communication with the smart cargo system. At step 620, a determination is made by the smart cargo system whether the location of the input 605 (i.e., the input “D”) is an approximate match based on a similarity test or other algorithmic matching solution to any previous events that have been recorded and stored in the smart cargo database. For example, this may include comparing the event data received in the input 605 to data contained in the EXCEL® spreadsheet file or the like that is stored and accessible in the smart cargo database. If a match is not found to the input 605 data, then the smart cargo system makes a determination at step 625 to continue with the delivery process. Alternatively, if a match is found by the smart cargo system by the comparison operations, then the flow will proceed to step 630 to determine whether the prior or previous delivery data suggest or is indicative of an event causing action. If this is the case, then the flow proceeds to step 635 to determine whether the events occur on the same day or close in time; if not, then the flow continues to step 625 to proceed with the delivery. At step 640, based on the affirmation of the event date concurrence and/or matching of data validations at step 645, the smart cargo system makes a determination to generate delivery routes that avoid or attempt to circumvent the location that results in the event causing action.

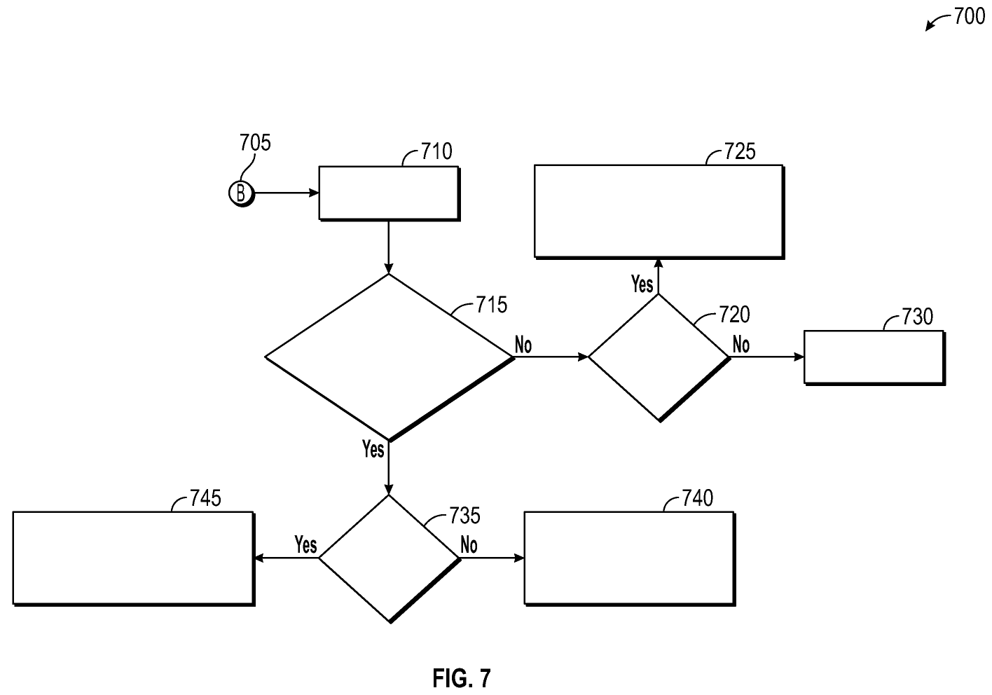

FIG. 7 is an exemplary flow diagram of a stage using customer input to improve package damage determinations in the smart delivery process of the smart cargo system in accordance with an exemplary embodiment. In FIG. 7, the input “B,” which is an input 705 of a customer's report of a damaged item which is delivered at step 710 to the customer. At step 715, a determination is made by the smart cargo system whether the customer has reported the damage through customer feedback. If no feedback was received, then at step 720, the smart cargo system determines whether any events were recorded. If no events were recorded, then at step 730, the delivery is completed, else at step 725, each event that causes the damage is recorded in the smart cargo delivery database along with the associated information (i.e., time, location, and accelerometer data). If customer feedback of damage is received, then at step 735, the smart cargo system checks if any events where recorded. If not, then at step 740, the smart cargo system determines if the damage was caused before or after the item was transported for delivery. Also, the smart cargo system determines that the item needs to be re-ordered. If events were recorded, then at step 745, the events that caused the damage are logged or recorded by the smart cargo system, and the item is re-ordered.

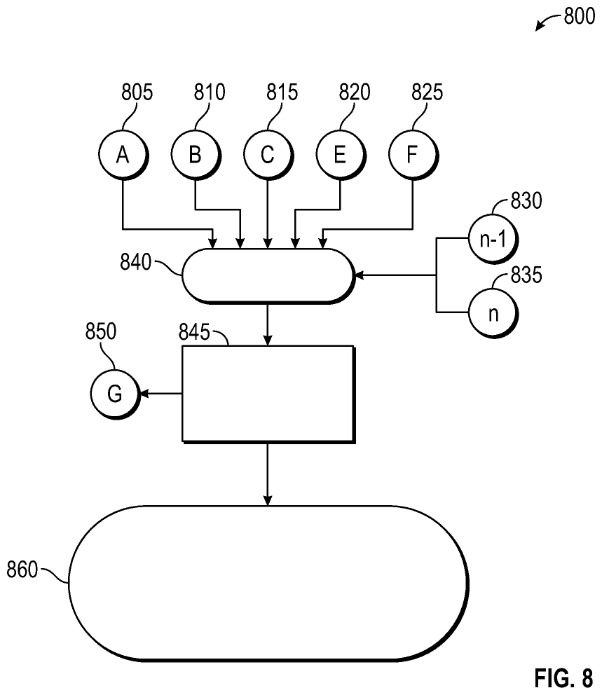

FIG. 8 is an exemplary flow diagram of a stage for calculating the overall delivery score in the smart delivery process of the smart cargo system in accordance with an exemplary embodiment. In FIG. 8 the smart cargo system 800 includes a set of inputs of input “A” which is an input 805 of loading score, input “B” which is an input 810 indicative of a customer's report if the item was damaged, input “C” which is an input 815 indicative of a drive time to reach a customer, input “E” which is an input 820 indicative of ordering of a new item if applicable, and an input “F” which is an input 825 of a driving score for the vehicle. Additional input “n−1” 830 and “n” 835 are added as desired. The delivery score is output “G” 850. The overall delivery score is calculated with each of the inputs (805, 810, 815, 820, 825, 830, and 835) automatically weighted equally even as the additional inputs 830, 835 are added. The total input weighting remains constant of the 100 percent dividend by the number of inputs where each input is reduced. The items are delivered to the customer at step 840; the smart cargo system calculates the overall score at step 845, and the delivery company at step 860 uses the data to improve the smart delivery process. For example, high performing delivery services are rewarded, while low performers are penalized, and opportunities for improvement in the low performers are identified and communicated in real-time or near real-time to enable immediate improvements in the smart delivery process.

In another exemplary embodiment, the inputs for the total delivery score are calculated with the inputs weighted differently or unequally. The different weightings for each of the inputs can be determined by subjective decision making by each delivery service provider, by empirical testing, or by prior historical data analysis. For example, if an employee loading score (i.e., input 805) and the driving score (i.e., input 825) are deemed of higher importance (i.e., the inputs may be found to be more directly related to item damage) than the use of customer feedback reports that can be subject to fraudulent entries, the overall delivery score can be generated in a manner to reflect the required emphasis with an uneven weighting of certain inputs.

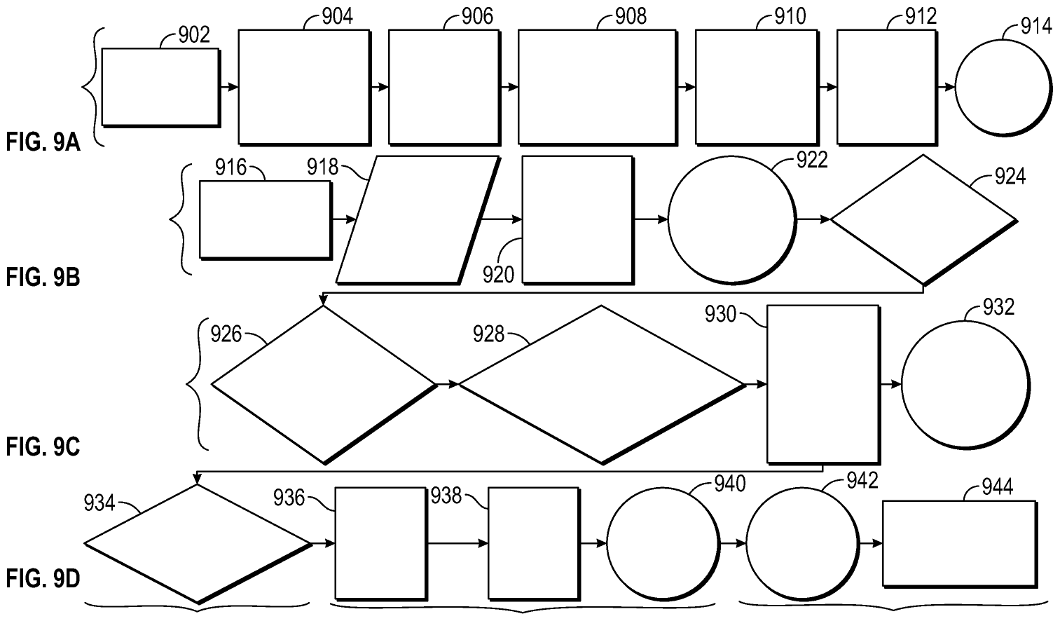

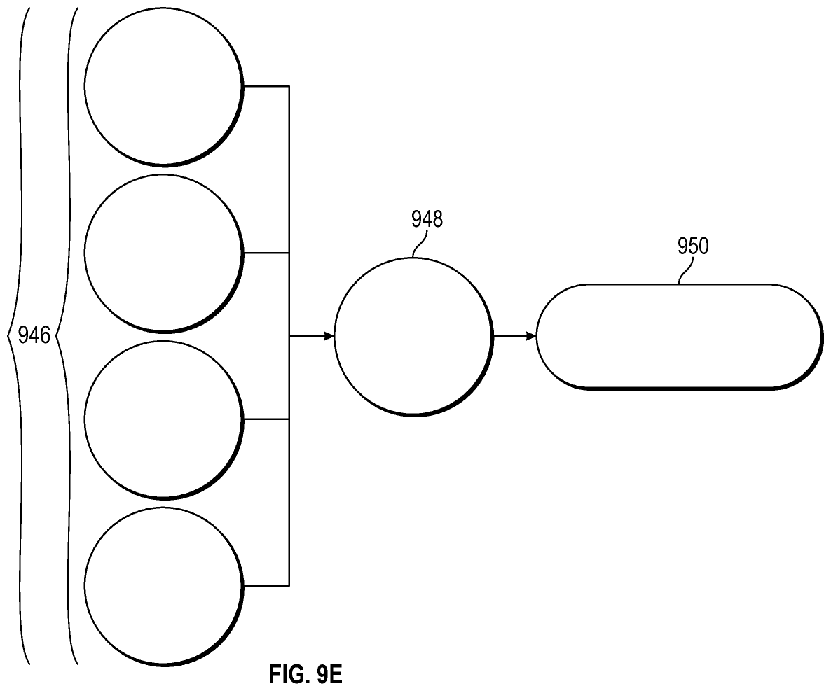

FIGS. 9A, 9B, 9C, 9D, and 9E illustrate exemplary flow diagrams of various use cases of stages of the smart delivery system in accordance with an embodiment.

FIG. 9A illustrates an exemplary flow diagram of the calculation of the loading scores includes: at step 902, scanning and loading the package into the ePallet; at step 904, receiving data from the bar code associated with the item of the package to identify the item, the weight based on item type, and the dimensions of the package/item; at step 906 to identify packages of similar size and weight which have been loaded before, at step 908 to determine by the smart cargo system a like package that has a given weight and size would have on the average have “4” or other number of touches, and take approximately 35 seconds or another period of time based on averaging of loading data to load the item into the ePallet; at step 910 to determine that an average of “3” touches and 30 seconds is required to load the package, at step 912, to determine that a new baseline for packages of the particular size and weight is required and to perform the necessary calculations; and at step 914 to report a new loading that likely can show improvements in the smart delivery process. FIG. 9B illustrates an exemplary flow of a use case for comparison of the vehicle and ePallet's accelerometer to determine package integrity. At step 916, the transport of the package is initiated on the ePallet. At step 918, the vehicle's accelerometer and ePallet's accelerometers are measured, and likely since the transport has only just been initiated, both accelerometers will be deemed in sync. Other data may also be recorded with the measurement such as location and time data. Next, at step 920, at approximately 15 minutes into a drive for the transport of the package, another measurement of the accelerometers is made by the smart cargo system. In this instance, the accelerometer is momentarily measured out of sync. Because the accelerometers are out of sync, the smart cargo system creates an “event” at step 922 and stores the relevant data. At step 924, the smart cargo system notifies the transport service after a comparison that the accelerometers are out of sync. In addition, in various exemplary embodiments, thresholds may be configured to make determinations as so how much out of sync the accelerometers are deemed and the kind of messaging that should be initiated to a transport service as a result. FIG. 9D illustrates several use stages that are the collection of GPS and timing data to minimize package damage in step 934; the comparison of the vehicle and ePallet accelerometers to determine package integrity in steps 936, 938, and 940; and the improvement of the delivery model via customer feedback in steps 942 and 944. Briefly, step 934, the smart cargo system scans previous data and recognizes that event with similar data acceleration has occurred. In the next stage, for comparisons of both accelerometers (i.e., the vehicle and ePallet's accelerometers), at step 936, the driver's score is deemed worsened based on the GPS and timing data. At step 938, the item is delivered to the customer, and at step 940, the smart cargo system reports drive time and the final driver score. In the improvement model use case, at step 942, the customer sends a report that an item is broken, and the smart cargo model at step 944 is improved by recording the customer broken item report and the validation that the item was in fact damaged. FIG. 9E illustrates an exemplary use case of the calculation of the overall score. The set of inputs 946 that make up the score are determined as the (1) the customer report of a broken item, (2) the report of the loading score improvement, (3) the report by the smart cargo system of the drive time, and the final drive score, and (4) the smart cargo system action of re-ordering an item (in this case the mirror item) that is deemed damaged. The set of inputs 946 are aggregated using an algorithmic solution at step 948, where the smart cargo system calculates the delivery score. At step 950, the delivery company uses data collected to identify and report inefficiencies to transport services and to reward transports that show improvements or achieve higher efficiencies.

Additionally, in the various exemplary embodiments, the smart cargo system can implement a predictive navigational algorithm (using a machine learning model) in order to predict if an anomaly event may be likely in an upcoming route segment. The method is operative to receive predictively (simulation) models generated from collected data (e.g., the data is streamed in real-time by a number of delivery vehicles and ePallets in use) related to the upcoming route segments. The method is next operative to simulate a virtual-navigation and delivery by the vehicle and ePallet of an upcoming segment in order to predict another anomaly in advance.

In an exemplary embodiment, the smart cargo system is operative to build at a backend server an AI model or using features such as anomalies or events detected, location, weather, road segment, road type, map version, construction, ambient traffic, and road material. This model may be used to capture damage conditions to items along with the delivery road segments and state changes in routes via messaging to the drivers by the smart cargo system.

In an exemplary embodiment, predicted event might be predicted using a machine learning model of the smart cargo system configured at the backend server using models including a factorial hidden Markov model, a filtering model, regression or classification model, or a neural network that continuously evaluates the data communicated by the vehicles and ePallets in the vicinity to processors at the backend server. Further, each machine learning model may be trained using collected delivery data or crowdsourced data where the smart cargo system can implement various algorithms to discover micro patterns of event data that cause item damage.

While at least one exemplary embodiment has been presented in the foregoing detailed description, it should be appreciated that a vast number of variations exist. It should also be appreciated that the exemplary embodiment or exemplary embodiments are only examples and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An apparatus for identifying damage causing events related to a package in a delivery activity, the apparatus comprising:
a processor at a backend server in communication with one or more delivery vehicles, each delivery vehicle equipped with an ePallet for effecting delivery of at least one package to a customer, the processor operative to:
communicate and maintain a communication link between one or more delivery vehicles equipped with ePallets in a transport of at least one package in one or more stages of the delivery activity to customers;
receive a plurality of location data in one or more delivery stages to identify locations that exhibit a likelihood to cause damage to the package that is being delivered wherein the package being delivered is carried in the ePallet of an equipped delivery vehicle performing a delivery activity;
determine a location that exhibits the likelihood to cause package damage by analysis of acceleration data by algorithms of the processer wherein the acceleration data is received from a first accelerometer located with the delivery vehicle and a second accelerometer located with the ePallet that carries the package for delivery;
compile a set of events based on acceleration data from the first and second accelerometer together with location indicative by the analysis of accelerometer data by the algorithms of the processor of an ePallet's movement desynced to a delivery vehicle's movement that can cause package damage; and
notify the delivery vehicle in a package delivery activity of an event likely causing package damage for the delivery vehicle to re-route a transport of the package delivery for avoidance of an identified damage-causing location.

2. The apparatus of claim 1, further comprising:
the processor at the backend server in communication with the one or more delivery vehicles equipped with the ePallet operative to:
re-order an item predicted to incur damage based on a compiled event indicative of causing package damage in advance of delivery of the package to the customer.

3. The apparatus of claim 2, further comprising:
the processor at the backend server in communication with the one or more delivery vehicles equipped with the ePallet operative to:
compile the set of events based on acceleration data received from a historical database of prior determined locations that have exhibited the likelihood to cause package damage.

4. The apparatus of claim 3, further comprising:
the processor at the backend server in communication with the one or more delivery vehicles equipped with the ePallet operative to:
calculate a total delivery score for a delivery service based on analysis of a set of input of delivery activities comprising a loading score, a number of customer feedback damage reports, a number of re-orders of replacement items, and a driving score in transporting the package for delivery.

5. The apparatus of claim 4, further comprising:
the processor at the backend server in communication with the one or more delivery vehicles equipped with the ePallet operative to:
validate the re-order the item predicted to incur damage based on the customer feedback damage report.

6. The apparatus of claim 5, further comprising:
the processor at the backend server in communication with the one or more delivery vehicles equipped with the ePallet operative to:
calculate the driving score based on data of analysis of differences of the accelerometer data by the algorithms of the processor of an ePallet's movement desynced to a delivery vehicle's movement that can cause package damage.

7. The apparatus of claim 6, further comprising:
the processor at the backend server in communication with the one or more delivery vehicles equipped with the ePallet operative to:
calculate the loading score based on a measure of a number of touches recorded of the package in transporting the package for delivery wherein each touch is identified by a barcode affixed to the package that is scanned in package delivery activities.

8. The apparatus of claim 7, further comprising:
the processor at the backend server in communication with the one or more delivery vehicles equipped with the ePallet operative to:
trace the package using the barcode that has been affixed to the package.

9. The apparatus of claim 8, further comprising:
the processor at the backend server in communication with the one or more delivery vehicles equipped with the ePallet operative to:
calculate the total delivery score for a delivery service based on a different weight attribute to each input of the set of input of delivery activities.

10. A method performed by a processor comprising:
communicating between the processor and one or more delivery vehicles equipped with ePallets in transport of at least one package in one or more delivery activities to transport packages to customers;
receiving, by the processor, a plurality of location data in one or more delivery activities for identifying locations exhibiting a likelihood for causing damage to the package in the course of a delivery wherein the package delivered is carried in the ePallet of an equipped delivery vehicle performing a particular delivery activity;
determining, by the processor, a location exhibiting a likelihood causing package damage by analyzing acceleration data by algorithms of the processer wherein the acceleration data is received from a first accelerometer located with a delivery vehicle and a second accelerometer located with the ePallet carrying a delivery package;
determining, by the processor, a set of events by analyzing acceleration data from the first and second accelerometer together with a location using an algorithmic solution of an ePallet's movement desynced to a delivery vehicle's movement that can cause package damage; and
notifying the delivery vehicle in performance of a package delivery activity of an event likely causing package damage for the delivery vehicle enabling re-routing of a transporting of the package delivery to avoid a damage-causing location.

11. The method of claim 10, further comprising:
re-ordering, by the processor, an item predicted to incur damage based on a compiled event indicative of causing package damage in advance of delivery of the package to a customer.

12. The method of claim 11, further comprising:
compiling, by the processor, by the set of events based on acceleration data received from a historical database of prior determined locations that have exhibited the likelihood to cause package damage.

13. The method of claim 12, further comprising:
calculating, by the processor, a total delivery score for a delivery service based on analysis of a set of inputs of delivery activities comprising a loading score, a number of customer feedback damage report, a number of re-orders of replacement items, and a driving score in transporting the package for delivery.

14. The method of claim 13, further comprising:
validating, by the processor, the re-order the item predicted to incur damage based on the customer feedback damage report.

15. The method of claim 14, further comprising:
calculating, by the processor, the driving score based on data of analyzing differences of the accelerometer data using algorithms of the processor of an amount of ePallet's movement desyncing to a delivery vehicle's movement related to causing package damage.

16. The method of claim 15, further comprising:
calculating, by the processor, the loading score based on measuring a number of touches occurring to a package in transporting the package for delivery wherein each touch is identified by a barcode affixed to the package that is scanned in package delivery activities.

17. The method of claim 16 further comprising:
tracing, by the processor, the package using the barcode that has been affixed to the package.

18. The method of claim 17, further comprising:
calculating, by the processor, the total delivery score for a delivery service based on a different weighting attributed to each input of the set of input of delivery activities.

19. A smart delivery system for transporting packages to customers comprising:
a processor at a backend server in communication with one or more delivery vehicles, each delivery vehicle equipped with an ePallet for effecting delivery of at least one package to a customer, the processor operative to:
communicate and maintain a communication link between one or more delivery vehicles equipped with ePallets in transport of at least one package in one or more stages of the delivery activity to customers;
receive a plurality of location data in one or more delivery stages to identify locations that exhibit a likelihood to cause damage to the package that is being delivered wherein the package being delivered is carried in the ePallet of an equipped delivery vehicle performing a delivery activity;
determine a location that exhibits the likelihood to cause package damage by analysis of acceleration data by algorithms of the processer wherein the acceleration data is received from a first accelerometer located with the delivery vehicle and a second accelerometer located with the ePallet that carries the package for delivery;
compile a set of events based on acceleration data from the first and second accelerometer together with location indicative by the analysis of the accelerometer data by the algorithms of the processor of an ePallet's movement desynced to a delivery vehicle's movement that can cause package damage; and
notify the delivery vehicle in a package delivery activity of an event likely causing package damage for the delivery vehicle to re-route a transport of the package delivery for avoidance of an identified damage-causing location.

20. The system of claim 19, further comprising:
the processor at the backend server in communication with the one or more delivery vehicles equipped with the ePallet operative to:
re-order an item predicted to incur damage based on a compiled event indicative of causing package damage in advance of delivery of the package to the customer wherein the compiled event is based in part on acceleration data received from a historical database of previously determined locations that have exhibited the likelihood to cause package damage.
